(19) United States
(12) Patent Application Publication
(10) Pub. No.: US 2005/0259298 A1
(43) Pub. Date: Nov. 24, 2005

(54) Duplex scan method of detecting document size

(75) Inventors: Szu Hui Lien, Hsinchu City (TW); Bo-Hsiang Wang, Taiping City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/129,372

(22) Filed: May 16, 2005

(30) Foreign Application Priority Data
May 18, 2004 (TW) 093113900

(51) Int. Cl. H04N 1/04

(52) U.S. Cl. 358/496; 358/449; 358/498

(57) ABSTRACT

A duplex scan method of detecting document size includes the steps of: (a) detecting size of a document and generating a size signal while moving the document from a sheet input tray to a reverse region; (b) moving the document across a scan region from the reverse region to the reverse region and scanning a back side of the document at the scan region according to the size signal; and (c) moving the document across the scan region from the reverse region to a sheet output tray and scanning a front side of the document at the scan region according to the size signal.

### BACKGROUND OF THE INVENTION

1. Field of the Invention

The invention relates to a duplex scan method of detecting document size, which enables scanners to operate more efficiently, and more particularly to a duplex scan method for firstly turning over a document and detecting the document size, and then scanning a back side and a front side of the document so as to speed up the document size detection and shorten the duplex scan operation time.

2. Description of the Related Art

When a conventional duplex scanning device with a single scanning module is performing duplex scanning processes, a document has to pass by a scan region three times. When the document is being transported across the scan region for the first time, the scanning module scans a front side of the document. When the document is being transported across the scan region for the second time, the scanning module scans a back side of the document. Finally, the document is being transported across the scan region for the third time to rearrange each document into the same order as that of the original stack.

FIG. 1 shows a duplex scanning device 100 disclosed in U.S. Pat. No. 5,784,680. As shown in FIG. 1, a first detector 122 can detect the existence of documents P such that a sheet-feeding mechanism 101 with the sheet pick-up, sheet separating and sheet feeding functions can start to feed the documents P, which is placed in a sheet input tray 102, into a first passageway 104 one by one. A second detector 124 detects whether the documents P have been separated. Then, the document P enters a second passageway 106 from the first passageway 104. A third detector 126 detects a leading edge and a trailing edge of the document, and the size of the document P can be detected accordingly. Next, the document P is being transported across a scan region 116, and a scanning module 130 scans a front side PA of the document at the scan region 116. Then, the document P enters a reverse region 112 through a third passageway 108, wherein a fourth detector 128 detects whether the document P has been transported out of the third passageway 108.

Next, the sheet-feeding mechanism 101 transports the document P in the reverse region 112 through a fourth passageway 110 and the second passageway 106 and across the scan region 116 and turns over the document P. At this time, the scanning module 130 scans a back side PB of the document P at the scan region 116. Then, the document P enters the reverse region 112 through the third passageway 108.

Next, the sheet-feeding mechanism 101 transports the document P in the reverse region 112 through the fourth passageway 110, the second passageway 106, the scan region 116 and the third passageway 108 in a reverse manner. Then, the document P enters a sheet output tray 114, wherein a guiding rod 118, which can be swung, guides the document P into the reverse region 112 or the sheet output tray 114.

When the document is transported across the scan region 116 for the first time, the duplex scanning device 100 performs the operations of scanning the document image and detecting the document size simultaneously. So, the scanning device 100 calculates the document size and transfers data while acquiring the image data. When the document passes by the scan region for the third time, however, the scanning device 100 does not scan the document and it is useless to detect the document size at this time. So, the data amount processed by the control processor of the scanning device 100 reaches a maximum when the document passes by the scan region for the first time, and a minimum when the document passes by the scan region for the third time. Consequently, the duplex scanning speed may decrease due to the simultaneous operations of scanning the document image and detecting the document size, and the overall control flow also tends to become complicated.

In addition, because the operations of document scanning and size detection are finished almost at the same time, the scanning device cannot quickly complete the operation of automatically cropping the scan region, or even a built-in printing unit or an external printing unit connected to the scanning device cannot perform the operation of selecting the size of the printing media. Thus, the scanning device cannot be used efficiently.

### SUMMARY OF THE INVENTION

It is therefore an object of the invention to provide a duplex scan method of detecting document size, wherein a document is firstly inverted, the document size is detected, and then a back side and a front side of the document are scanned in order to speed up the document size detection and shorten the duplex scan operation time.

To achieve the above-mentioned object, the invention provides a duplex scan method, which includes the steps of: (a) detecting size of a document and generating a size signal while moving the document from a sheet input tray to a reverse region; (b) moving the document across a scan region from the reverse region to the reverse region and scanning a back side of the document at the scan region according to the size signal; and (c) moving the document across the scan region from the reverse region to a sheet output tray and scanning a front side of the document at the scan region according to the size signal.

The duplex scan method may further include the steps of selecting a size of a printing medium and printing a front side image and a back side image of the document.

### BRIEF DESCRIPTION OF THE DRAWINGS

FIG. 1 shows a duplex scanning device disclosed in U.S. Pat. No. 5,784,680.

FIG. 2 is a flow chart showing a duplex scan method of the invention.

### DETAILED DESCRIPTION OF THE INVENTION

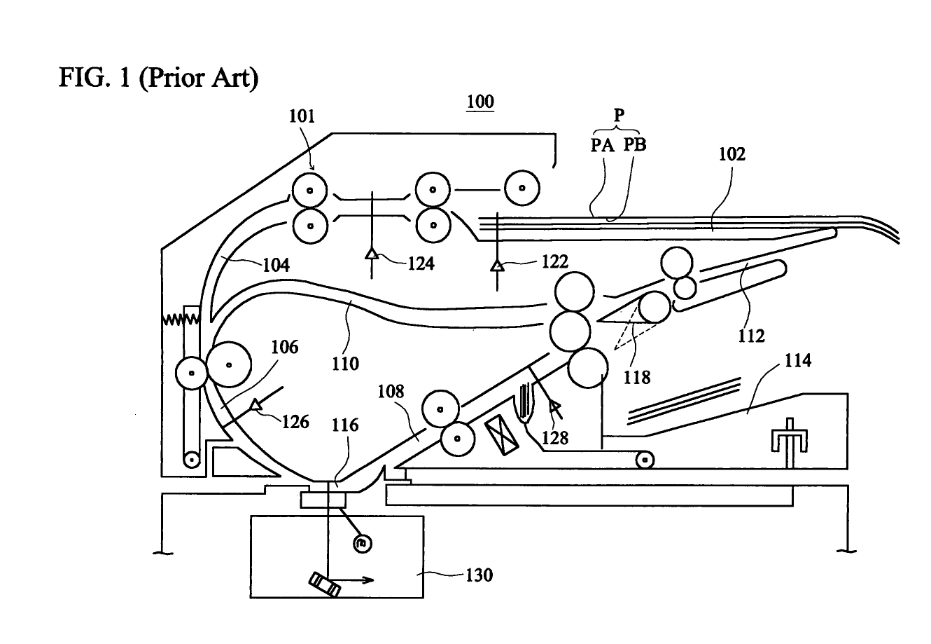

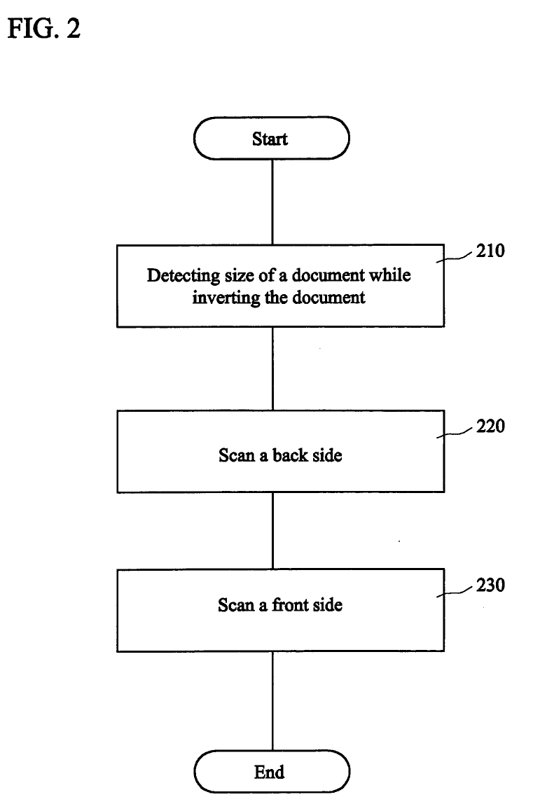

FIG. 2 is a flow chart showing a duplex scan method of the invention. The scan method of the invention is also applied to the scanning device of FIG. 1. As shown in FIGS. 2 and 1, step 210 is a pre-inverting step, in which the size of the document P is detected and thus a size signal is generated while the document P is moved through the first passageway 104, the second passageway 106, the scan region 116 and the third passageway 108 from the sheet input tray 102 to the reverse region 112. The size of the document may include the length and/or width of the document. The length of the document may be determined according to a detected leading edge and a detected trailing edge of the document.

Then, in step 220, the document P is transported across the scan region 116 from the reverse region 112 to the reverse region 112, and the scanning module 130 scans the back side PB of the document P at the scan region 116 according to a default mode or the size signal. In this step, the document P travels from the reverse region 112, through the fourth passageway 110, the second passageway 106, the scan region 116, and the third passageway 108, then to the reverse region 112.

Next, in step 230, the document P is transported across the scan region 116 from the reverse region 112 to the sheet output tray 114, and the scanning module 130 scans the front side PA of the document P at the scan region 116 according to the default mode or the size signal. In this step, the document P travels from the reverse region 112, through the fourth passageway 110, the second passageway 106, the scan region 116, and the third passageway 108, then to the sheet output tray 114.

Because the document has been previously inverted in step 210, the order of a stack of documents remains unchanged when the duplex scanning processes is complete.

Because only the size of the document is detected in step 210 and no scanning operation is involved in step 210, the document size detection procedure can be completed before the scanning of the back side PB of the document P starts. When the scan method is implemented on a multi-function peripheral having a built-in printing unit or being connected to an external printing unit, the printing unit receives the size signal and selects a printing medium, such as a sheet of paper, of a fitting size.

In addition, the built-in or external printing unit can print data first on the back side and then on the front side according to the method of the invention, so the time required for turning over the document can be omitted. Alternatively, in the prior art multi-function peripheral, which scans the front side and then the back side of the document, if the order of a stack of sheets of paper is to be kept unchanged without additionally inverting the sheets of paper, the front side image data has to be stored because the back side image has to be printed first before the front side image is printed. So, a memory of a large capacity has to be integrated.

According to the above-mentioned descriptions, when the printing device is externally connected to the scanning device, the duplex scan method of the invention may further include the steps of: processing the back side image obtained after scanning the back side of the document into a back side printing signal and outputting the back side printing signal to the external printing device for printing; and processing the front side image obtained after scanning the front side of the document into a front side printing signal and outputting the front side printing signal to the external printing device for printing. In addition, it is also possible to output the size signal to the external printing device such that the external printing device automatically selects the size of the printing medium.

Alternatively, when the printing device is built in the duplex scanning device, the duplex scan method of the invention may further include the steps of processing the back side image obtained after scanning the back side of the document into a processed back side image and printing the processed back side image on the back side of the sheet; and processing the front side image obtained after scanning the front side of the document into a processed front side image and printing the processed front side image on the front side of the sheet. In addition, the duplex scanning device may further determine the size of the printing medium according to the size signal, and then print the back side and front side images.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A duplex scan method of detecting document size comprising the steps of:
(a) detecting size of a document and generating a size signal while moving the document from a sheet input tray to a reverse region;
(b) moving the document across a scan region from the reverse region to the reverse region and scanning a back side of the document at the scan region; and
(c) moving the document across the scan region from the reverse region to a sheet output tray and scanning a front side of the document at the scan region.

2. The method according to claim 1, wherein the size of the document comprises at least one of a length and a width.

3. The method according to claim 1, further comprising the steps of:
processing a back side image obtained after scanning the back side of the document into a back side printing signal and outputting the back side printing signal to a printing device for printing; and
processing a front side image obtained after scanning the front side of the document into a front side printing signal and outputting the front side printing signal to the printing device for printing.

4. The method according to claim 3, further comprising the steps of:
outputting the size signal to the printing device such that the printing device automatically selects a size of a printing medium.

5. The method according to claim 1, further comprising the steps of:
processing a back side image obtained after scanning the back side of the document into a processed back side image and printing the processed back side image on a back side of a sheet; and
processing a front side image obtained after scanning the front side of the document into a processed front side image and printing the processed front side image on a front side of the sheet.

6. The method according to claim 1, further comprising the steps of:
determining a size of a printing medium according to the size signal;
processing a back side image obtained after scanning the back side of the document into a processed back side image and printing the processed back side image on a back side of the printing medium; and
processing a front side image obtained after scanning the front side of the document into a processed front side image and printing the processed front side image on a front side of the printing medium.

7. The method according to claim 1, wherein the back side of the document is scanned according to the size signal.

8. The method according to claim 1, wherein the front side of the document is scanned according to the size signal.
